(19) United States
(12) Patent Application Publication
(10) Pub. No.: US 2025/0033394 A1
(43) Pub. Date: Jan. 30, 2025

(54) LIQUID DISCHARGE APPARATUS AND CONTROL METHOD

(71) Applicant: CANON KABUSHIKI KAISHA, Tokyo (JP)

(72) Inventors: ATSUSHI KOHNOTOH, Tokyo (JP); SHUHEI YAMAGUCHI, Kanagawa (JP); KEN TAKENAGA, Kanagawa (JP); DAIJU TAKEDA, Kanagawa (JP); KOUSUKE TANAKA, Kanagawa (JP)

(21) Appl. No.: 18/785,695

(22) Filed: Jul. 26, 2024

(30) Foreign Application Priority Data
Jul. 28, 2023 (JP) 2023-123762

(51) Int. Cl. B41J 29/393; B41J 2/175; B41J 25/00; B41J 29/13; B41J 29/46

(52) U.S. Cl. CPC B41J 29/393; B41J 2/17596; B41J 25/001; B41J 29/13; B41J 29/46

(57) ABSTRACT

A liquid discharge apparatus includes a carriage on which a discharge head configured to discharge a liquid is mounted, the carriage being configured to move in a predetermined direction; and an operation unit configured to be placed near a movement region of the carriage and configured to be operated by a user. When a predetermined condition is satisfied, the carriage moves to a retreat position on the movement region and then moves to a predetermined position on the movement region. The retreat position is a position on an opposite side of the predetermined position to the operation unit in the predetermined direction.

### BACKGROUND OF THE INVENTION

### Field of the Invention

The present invention relates to a liquid discharge apparatus and a control method.

### Description of the Related Art

Some liquid discharge apparatuses are provided with an operation unit that can be operated by the user. For example, Japanese Patent Laid-Open No. 2020-168842 discloses a printing apparatus internally including a valve that opens and closes a tube between a printhead and an ink tank. The user can manually operate the valve. The carriage moves while being loaded with the printhead. When replacing the printhead, the user operates the valve.

When the user operates the valve, the sudden movement of the carriage for the replacement of the printhead sometimes surprises the user.

### SUMMARY OF THE INVENTION

The present invention provides a technique of safely moving the carriage.

According to an aspect of the present invention, there is provided a liquid discharge apparatus comprising: a carriage on which a discharge head configured to discharge a liquid is mounted, the carriage being configured to move in a predetermined direction; and an operation unit configured to be placed near a movement region of the carriage and configured to be operated by a user, wherein when a predetermined condition is satisfied, the carriage moves to a retreat position on the movement region and then moves to a predetermined position on the movement region, and the retreat position is a position on an opposite side of the predetermined position to the operation unit in the predetermined direction.

Further features of the present invention will become apparent from the following description of exemplary embodiments (with reference to the attached drawings).

### BRIEF DESCRIPTION OF THE DRAWINGS

FIG. 1 is a perspective view of a liquid discharge apparatus according to one embodiment of the present invention;

FIG. 2 is a perspective view of the liquid discharge apparatus in FIG. 1 with a cover member opened;

FIG. 3 is a perspective view of the internal structure of the apparatus main body;

FIG. 4 is a view for explaining an ink supply system between an ink tank and a printhead;

FIGS. 5A to 5D are views for explaining a valve;

FIGS. 6A and 6B are views for explaining a recovery unit;

FIG. 7 is a view for explaining a suction pump;

FIG. 8 is a view for explaining the positional relationship between the movement region of the carriage and another arrangement;

FIG. 9 is a perspective view of the back surface side of the carriage;

FIG. 10 is a perspective view of the back surface side of a rear cover;

FIG. 11A is a perspective view of a fixing structure from which a damper and the like are removed;

FIG. 11B is a perspective view of the fixing structure after assembly;

FIG. 12A is a plan view of a support portion;

FIG. 12B is a plan view of the support portion to which the damper is attached;

FIG. 12C is a plan view of the support portion after assembly;

FIG. 13 is a view for explaining the fixing structure of an endless belt;

FIG. 14 is a block diagram of the control circuit of the liquid discharge apparatus in FIG. 1;

FIG. 15 is a flowchart showing a control example of the liquid discharge apparatus in FIG. 1; and

FIG. 16 is a flowchart showing a control example of the liquid discharge apparatus in FIG. 1.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### <Outline of Liquid Discharge Apparatus>

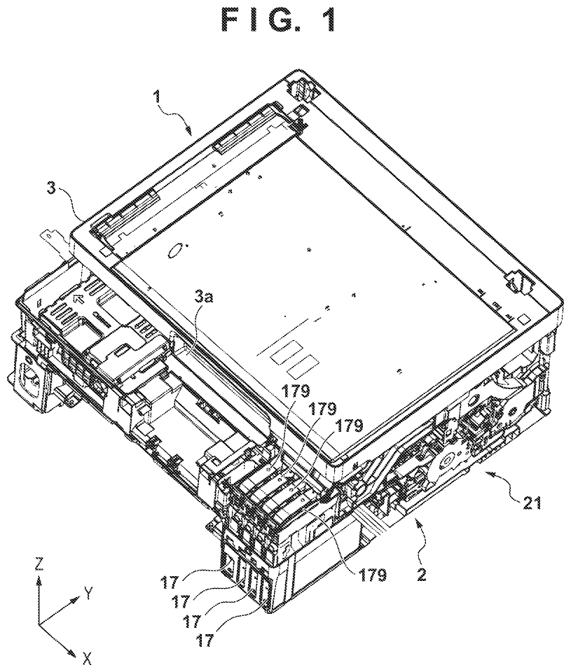

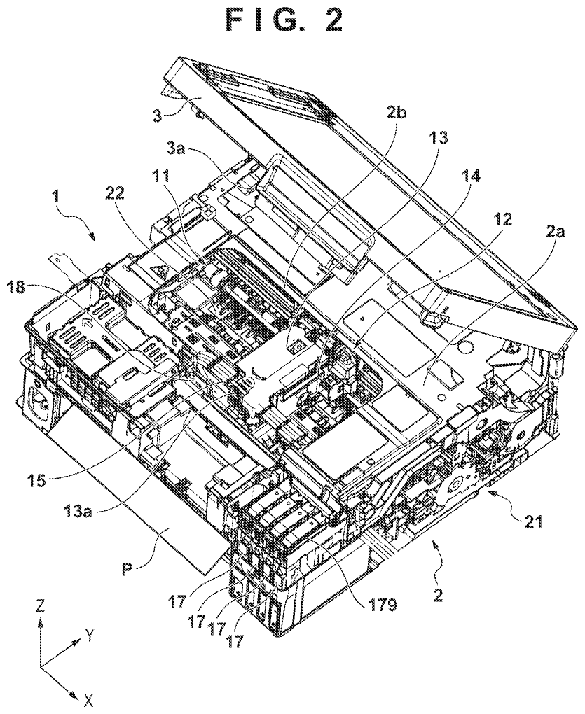

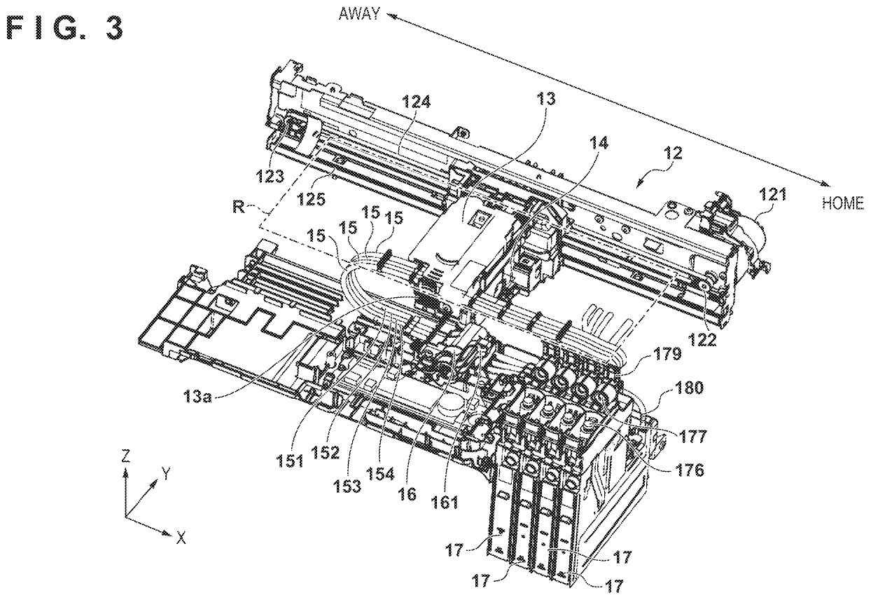

FIGS. 1 and 2 are external views of a liquid discharge apparatus 1 according to one embodiment of the present invention. FIG. 3 is a perspective view of the internal structure of the liquid discharge apparatus 1. Referring to each view, arrows X, Y, and Z indicate directions intersecting with each other. In this embodiment, the arrows X and Y are orthogonal horizontal directions and respectively indicate the width and depth directions of the liquid discharge apparatus 1, and the arrow Z indicates the vertical direction (height direction).

The liquid discharge apparatus 1 according to this embodiment is an inkjet printing apparatus that prints an image on a print medium by discharging ink as a liquid onto the print medium. However, the present invention can be applied to a liquid discharge apparatus in another form. In addition, “print” is not limited to formation of significant information such as a character or figure and includes, in a broad sense, formation of an image, design, pattern, or the like on a print medium or processing of a medium, regardless of whether information is significant or insignificant, or whether information is so visualized as to allow the user to visually perceive it. Also, in this embodiment, “print medium” is assumed to be sheet-shaped paper, but it may be fabric, plastic film, or the like.

The liquid discharge apparatus 1 includes an apparatus main body 2 and a cover member 3 covering the upper portion of the apparatus main body 2. The cover member 3 can be displaced between the open position and the closed position. FIG. 1 shows a state in which the cover member 3 is at the closed position. FIG. 2 shows a state in which the cover member 3 is at the open position. At the depth position of the apparatus main body 2 in the Y direction, the cover member 3 is supported so as to be pivotal about an axis in the X direction. The user can manually open and close the cover member 3. The cover member 3 is basically located at the closed position at the time of using the liquid discharge apparatus 1. The cover member 3 is operated to the open position at the time of maintenance or the like in the apparatus main body 2.

The apparatus main body 2 includes a conveyance unit 11 that conveys a print medium P, a printhead (discharge head) 14 that discharges liquid ink onto the print medium P, a carriage 13 that moves while being loaded with the printhead 14, and a moving mechanism 12 that moves the carriage 13.

The conveyance unit 11 includes a conveyance roller extending in the X direction and a pinch roller that comes into pressure contact with the conveyance roller and conveys the print medium P in the Y direction (sub-scanning direction) by rotating with the print medium P held between the conveyance roller and the pinch roller.

The printhead 14 discharges ink supplied from an ink tank 17 as a reservoir that retains ink through a pipe 15. The printhead 14 is placed so as to face a platen 22 and performs printing by discharging ink onto the print medium P on the platen 22. A plurality of ink tanks 17 are provided. In this embodiment, four ink tanks 17 are provided. The ink tanks 17 respectively accommodate different types of inks. The four ink tanks 17 respectively accommodate, for example, black ink, yellow ink, magenta ink, and cyan ink. An upper portion of the ink tank 17 is provided with an inlet 176. The user can replenish ink into the ink tank 17 by injecting the ink from a replenishment bottle into the inlet 176. The inlet 176 can be capped by a cap 177 attached to a tank cover 179. The tank cover 179 is configured to open/close the cap 177 by pivotal movement. When the tank cover 179 is closed, the inlet 176 is capped by the cap 177. Note that the cap 177 may be configured independently of the tank cover 179.

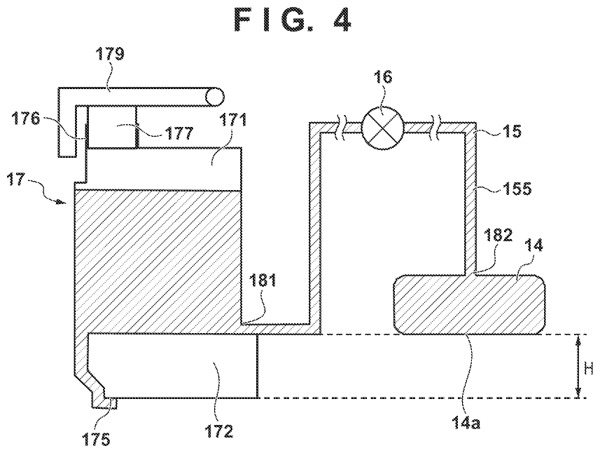

The printhead 14 has a discharge surface 14a on which a plurality of nozzles for discharging ink are formed (see FIG. 4). Each nozzle is provided with, for example, an electricity/heat conversion element (heater). The electricity/heat conversion element is energized to be heated to make ink foam, thereby discharging the ink with the foaming energy. The apparatus main body 2 is provided with a recovery unit 21 that maintains and recovers the ink discharge performance of the printhead 14.

The carriage 13 reciprocates in the X direction (main scanning direction) while being loaded with the printhead 14. An image is printed on the print medium P by discharging ink from the printhead 14 onto the print medium P in the process of movement of the carriage 13. This operation is sometimes called print scanning. The liquid discharge apparatus 1 according to this embodiment is a serial type inkjet printing apparatus having the printhead 14 mounted on the carriage 13 that reciprocally moves. A printing operation is performed by alternately repeating a conveying operation of intermittently conveying the print medium P with the conveyance unit 11 and print scanning.

The printhead 14 is detachably provided on the carriage 13. The user can remove the printhead 14 from the carriage 13 by operating an attaching/detaching operation unit 13a. The attaching/detaching operation unit 13a is a pivotal lever type operation unit.

The moving mechanism 12 is a belt transmission mechanism using a carriage motor 121 as a drive source. The moving mechanism 12 includes a drive pulley 122 rotated by the carriage motor 121 and a driven roller 123. These pulleys are separated from each other in the X direction. An endless belt 124 is wound between the drive pulley 122 and the driven roller 123. The moving mechanism 12 also includes a guide member 125 that extend in the X direction and defines a movement region R of the carriage 13. The carriage 13 can be moved in the X direction by being guided by the guide member 125. Part of the endless belt 124 is fixed to the carriage 13. As the endless belt 124 travels, the carriage 13 moves.

The pipes 15 (a total of four in this embodiment) are flexible tubes that are provided for the respective types of ink and connect between the ink tanks 17 and the printhead 14. A midway portion of the pipe 15 is provided with a valve 16. The valve 16 is a valve that switches between supply and interruption of ink with respect to the printhead 14. The valve 16 is a manual valve having an opening/closing operation unit 161 that can be operated by the user. The user can switch between supply and interruption of ink by operating the valve 16.

That is, when the valve 16 is in the open state, ink can be supplied from the ink tank 17 to the printhead 14. Accordingly, the liquid discharge apparatus 1 can print on the print medium P. In contrast, when the valve 16 is in the closed state, no ink is supplied from the ink tank 17 to the printhead 14, and the user can perform a replacing operation for the printhead 14.

The valve 16 is placed at a position near the movement region R of the carriage 13. In other words, the valve 16 is placed at a position along the movement region R of the carriage 13. In this embodiment, the valve 16 is placed in front of the movement region R in the Y direction on the right side within the width of the movement region R in the X direction (on the side where the ink tank 17 and the carriage motor 121 or the recovery unit 21 are provided). In addition, the valve 16 is placed in a passage region of the print medium P in the X direction and placed above the print medium P in the Z direction.

The pipe 15 is routed so as to avoid a position above the valve 16 (especially, the opening/closing operation unit 161) and so as not to interfere with the user when he/she operates the opening/closing operation unit 161.

The apparatus main body 2 includes a housing 2a surrounding the above arrangement. An opening portion 2b is formed in an upper middle portion of the housing 2a. As shown in FIG. 2, when the cover member 3 is opened, the carriage 13 (the printhead 14), the valve 16, and the like are exposed from the opening portion 2b.

The apparatus main body 2 is provided with a cover sensor 18 that can detect the open/closed state of the cover member 3. The cover member 3 is internally provided with a detection piece 3a. When the detection piece 3a is in contact with the cover sensor 18, it is detected that the cover member 3 is in the closed state. When the detection piece 3a is not in contact with the cover sensor 18, it is detected that the cover member 3 is in the open state.

### <Ink Supply System>

The supply of ink from the ink tank 17 to the printhead 14 will be described with reference to FIG. 4. An ink supply path 155 is formed by the pipe 15. The pipe 15 is connected to a joint portion 181 of the ink tank 17 and a joint portion 182 of the printhead 14. The valve 16 is provided in the pipe 15 between the joint portion 181 and the joint portion 182.

The ink tank 17 has an ink accommodation chamber 171 and a buffer chamber 172. A vapor/liquid exchange portion 175 is provided at a position lower than the discharge surface 14a of the printhead 14 by a height H in the Z direction. That is, a negative pressure due to a head difference corresponding to the height H is exerted on the discharge surface 14a. The vapor/liquid exchange portion 175 is a portion into which air equal in amount to the ink discharged from the printhead 14 is introduced. In this portion, ink is normally held at the position indicated in FIG. 4 due to the meniscus of ink. The buffer chamber 172 can accommodate ink pushed out as the meniscus of ink in the vapor/liquid exchange portion 175 is broken when the air in the ink accommodation chamber 171 is expanded due to atmospheric pressure variation, temperature change, or the like. The buffer chamber 172 communicates with an atmospheric air communication path communicating with atmospheric air. Note that the arrangement of the ink tank 17 is not limited to this, and the buffer chamber 172 may be provided above the ink accommodation chamber 171.

The joint portion 182 is provided for the attaching/detaching operation unit 13a. When the user operates the attaching/detaching operation unit 13a in a direction to open for the removal of the printhead 14 from the carriage 13, the joint portion 182 comes off from the printhead 14. This shuts off the connection between the pipe 15 and the printhead 14. In addition, when attaching the printhead 14 to the carriage 13, the user closes the attaching/detaching operation unit 13a and implements joint connection with the joint portion 182 by pressing a press portion (not shown). With joint connection with the joint portion 182, the pipe 15 communicates with the flow channel of the printhead 14, thereby allowing the supply of ink to the printhead 14.

A procedure until a printing operation can be performed in this embodiment will be described. When injecting ink into the ink tank 17, the user removes the cap 177 upon opening the tank cover 179 and injects ink from an ink bottle or the like into the ink tank 17 through the inlet 176. Upon completing the injection of ink, the user closes the tank cover 179 and hermetically seals the inlet 176 with the cap 177.

Upon completion of the injection of ink, the recovery unit 21 sucks ink from the discharge surface 14a of the printhead 14. With this sucking operation, the pipe 15 and the printhead 14 are filled with ink. Note that the completion of the injection of ink is detected as the cover sensor 18 detects that the cover member 3 is closed. However, the present invention is not limited thereto, and the completion of the injection of ink may be detected by detecting the injection of a predetermined amount or more of ink with a remaining amount detection sensor that detects the remaining amount of ink in the ink tank 17.

When ink is discharged accompanying a printing operation from the discharge surface 14a of the printhead 14 filled with ink, the negative pressure in the printhead 14 increases by a decrease in ink, and ink is supplied from the ink tank 17 to the printhead 14. This causes ink to be continuously supplied from the ink tank 17 to the printhead 14 until the amount of ink in the ink tank 17 becomes less than a predetermined amount.

### <Valve>

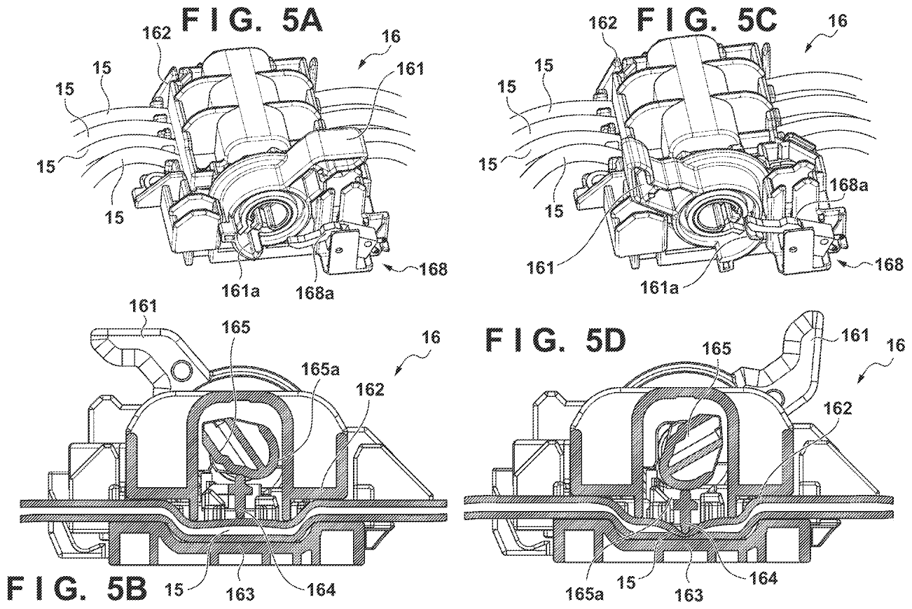

The arrangement of the valve 16 according to this embodiment will be described next. FIGS. 5A to 5D are views for explaining the valve 16. FIGS. 5A and 5B show a case where the valve 16 is in the open state. FIGS. 5C and 5D show a case where the valve 16 is in the closed state.

The valve 16 includes the opening/closing operation unit 161 that can be operated by the user, a holding portion 162, a receiving member 163, a displacement member 164, and a cam 165. The holding portion 162 holds part of the pipe 15. Part of the pipe 15 bends accompanying the movement of the printhead 14. The holding portion 162 holds a portion of the pipe 15 which is immobile regardless of the movement of the printhead 14.

The displacement member 164 is a member that can be displaced in a direction to interfere with the pipe 15. In other words, the displacement member 164 is provided so as to be able to advance/retreat with respect to the pipe 15. In addition, the receiving member 163 is a member for receiving the displacement member 164. The receiving member 163 is provided on the opposite side of the pipe 15 to the side where the displacement member 164 is provided. The displacement member 164 presses the pipe 15 against the receiving member 163 and crushes the pipe 15, thereby blocking the pipe 15 (the ink supply path 155). As described above, the valve 16 according to this embodiment is configured to interrupt the supply of ink to the printhead 14 by crushing the pipe 15.

The cam 165 displaces the displacement member 164. In this embodiment, the cam 165 is provided integrally with the opening/closing operation unit 161. The cam 165 is in contact with the displacement member 164 at a cam surface 165a. When the user operates the opening/closing operation unit 161, the cam 165 rotates accompanying the operation, and the displacement member 164 pushed by the cam surface 165a is displaced. This allows the user to open and close the valve 16 via the opening/closing operation unit 161, that is, block and release the pipe 15 (the ink supply path 155).

The valve 16 is provided with a valve sensor 168 that detects an operation with respect to the opening/closing operation unit 161 of the valve 16. In this embodiment, the valve sensor 168 is a switch that mechanically operates. The detection result indicates the open/closed state of the valve 16. When the user operates the opening/closing operation unit 161, an actuating member 161a provided on the opening/closing operation unit 161 makes a movable portion 168a of the valve sensor 168 pivot. The valve sensor 168 includes an optical sensor that detects the pivotal movement of the movable portion 168a. This enables the valve sensor 168 to detect the open/closed state of the valve 16. Note that the arrangement of the valve sensor 168 is an example and can adopt another known arrangement.

The next is a description of the operation of the valve 16 according to this embodiment blocking the pipe 15. FIGS. 5A and 5B show a state (open state) in which the displacement member 164 does not crush the pipe 15, and the ink supply path 155 communicates with the pipe 15. In this state, ink in the pipe 15 can be supplied from the ink tank 17 to the printhead 14 through the ink supply path 155. When the user rotates the opening/closing operation unit 161 to the opposite side, the cam surface 165a of the cam 165 provided integrally with the valve 16 also rotates, and the cam surface 165a displaces the displacement member 164 in a direction to interfere with the pipe 15.

FIGS. 5C and 5D show a state (blocked state) in which the displacement member 164 crushes the pipe 15, and the ink supply path 155 is blocked. The pipe 15 is crushed between the displacement member 164 and the receiving member 163, and the ink supply path 155 is blocked. This results in a state in which ink in the ink tank 17 cannot be supplied to the printhead 14. If there is no ink in the ink tank 17, atmospheric air does not communicate with the printhead 14.

In this embodiment, the opening/closing operation unit 161 is placed at a position at which it is covered by the cover member 3 (see FIGS. 1 to 3). That is, the opening/closing operation unit 161 is provided so as to be exposed when the cover member 3 opens. The liquid discharge apparatus 1 is controlled so as not to perform a printing operation using the printhead 14 while the open state of the cover member 3 is detected by the cover sensor 18. The opening/closing operation unit 161 is provided inside the cover member 3 to make it possible to prevent the user from mistakenly operating the opening/closing operation unit 161 during a printing operation of the liquid discharge apparatus 1. In addition, since this embodiment is provided with the cover sensor 18, the liquid discharge apparatus 1 can detect with the cover sensor 18 whether the user is ready to operate the opening/closing operation unit 161.

Note that this embodiment uses the single valve 16 for the four pipes 15. However, the valve 16 may be provided for each pipe 15. Alternatively, the valves 16 (a total of two) may be respectively provided for the pipe 15 for a black ink and the pipe 15 for color inks.

### <Recovery Unit>

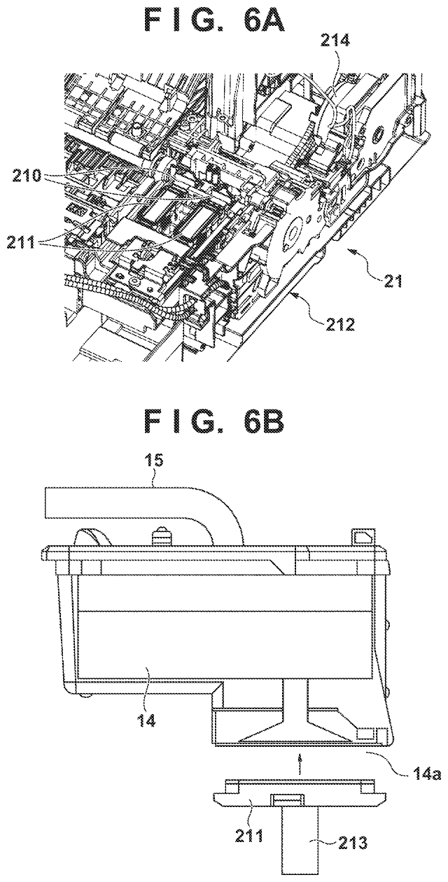

The recovery unit 21 will be described with reference to FIGS. 6A and 6B. FIGS. 6A and 6B are views for explaining the recovery unit 21. Specifically, FIG. 6A is a perspective view of the recovery unit 21, and FIG. 6B is a schematic view of the recovery unit 21.

The recovery unit 21 is provided in the housing 2a. The recovery unit 21 includes a suction cap 211 that caps the printhead 14, a suction mechanism 212 that sucks ink in the suction cap 211, and a wiper 210 for wiping the discharge surface 14a. The suction mechanism 212 has a suction tube 213 connected to the suction cap 211 and a suction pump 214 that sucks ink in the suction cap 211 through the suction tube 213.

The suction tube 213 is a suction path forming member that forms an ink suction path for sucking ink in the suction cap 211. In addition, in this embodiment, the suction tube 213 is formed of a member having flexibility, such as elastomer, like the pipe 15.

The suction cap 211 is placed inside the movement region R of the projection optical system 6 and outside the passage region of the print medium P in the X direction. At the time of recovering the printhead 14, the carriage 13 moves to a position at which the discharge surface 14a of the printhead 14 faces the suction cap 211. The suction cap 211 is provided so as to be able to advance/retreat with respect to the discharge surface 14a of the printhead 14 and can cap the discharge surface 14a provided with the nozzles from below.

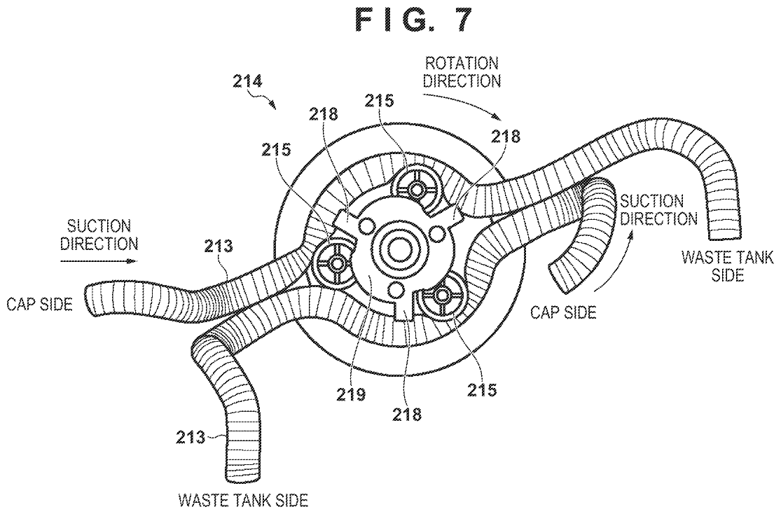

The following is a description of the operation of the suction mechanism 212 sucking ink in the suction cap 211. FIG. 7 is a view for explaining the suction pump 214 and is a sectional view showing an outline of the suction pump 214. In this embodiment, the suction mechanism 212 includes the two suction tubes 213 for a black ink and color inks.

The suction pump 214 includes a roller 215, a rotating member 219, and a roller driving member 218 provided so as to protrude from the rotating member 219 to the outside in the radial direction. The rotating member 219 is rotated by a motor (not shown).

The roller 215 is provided so as to be able to circle around the rotational axis of the rotating member 219. When the rotating member 219 rotates (revolves), the roller driving member 218 circles around the axis of the rotating member 219. When the roller driving member 218 circles around the axis of the rotating member 219 in contact with the roller 215, the roller 215 circles around the axis of the rotating member 219.

The suction mechanism 212 generates a negative pressure in the suction cap 211 by causing the roller 215 to circle around the rotating member 219 and squeeze the suction tube 213 while the discharge surface 14a is covered by the suction cap 211, thereby sucking ink.

In this embodiment, the two suction tubes 213 are provided vertically side by side so as to sandwich the rotating member 219. In addition, the embodiment is provided with the three rollers 215 and configured to simultaneously perform suction with the two suction tubes 213 by making the three rollers rotate so as to sequentially squeeze the two suction tubes 213. In addition, one end of the suction tube 213 is connected to a waste tank (not shown), and the ink sucked by the suction pump 214 is discharged into the waste tank through the suction tube 213.

In this embodiment, the suction pump 214 can block the suction tube 213 by stopping the drive of a pump driving unit 216 while the roller 215 crushes the suction tube 213. That is, in the embodiment, the suction pump 214 also serves as a blocking valve for the suction tube 213. This makes it possible to decrease the number of components of the liquid discharge apparatus 1. Note that it is possible to adopt an arrangement including a blocking valve for the suction tube 213 separately from the suction pump 214. In this case, it is possible to adopt one of valves with various arrangements including a valve that can be manually operated, such as the valve 16, and a valve that can automatically open/close with a drive source such as a motor.

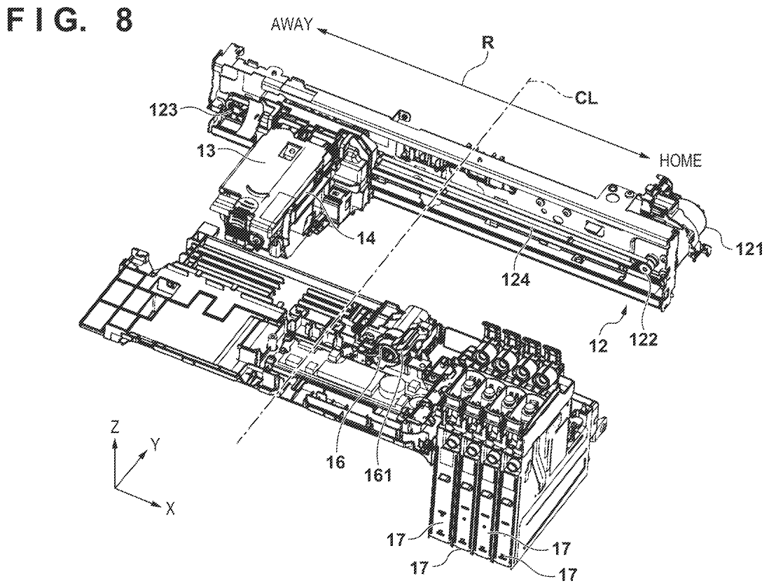

In this embodiment, as shown in FIGS. 1 and 2, the recovery unit 21 is placed on one end portion of the apparatus main body 2 in the X direction. As shown in FIG. 8, when one end portion of the movement region R of the carriage 13 is defined as a home, and the other end portion is defined as an away, the recovery unit 21 is placed on the home side with respect to a central line CL of the movement region R. In addition, the ink tank 17 and the valve 16 are also placed on the home side with respect to the central line CL.

### <Fixing Structure of Endless Belt>

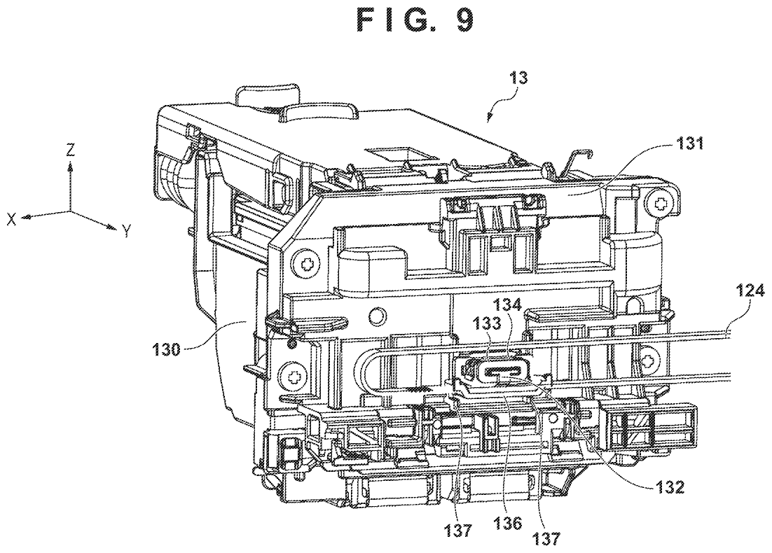

The fixing structure between the carriage 13 and the endless belt 124 will be described with reference to FIG. 9. FIG. 9 is a perspective view of the back surface side of the carriage 13. The carriage 13 includes a main body 130 that supports the printhead 14 and a rear cover 131 that forms the back portion (rear portion) of the carriage 13. The rear cover 131 is provided with the fixing structure of the endless belt 124. The fixing structure includes a support portion 132 integrally formed on the rear cover 131, a damper 133 attached to the support portion 132, a holding member 136 that holds the endless belt 124, and a holder 134.

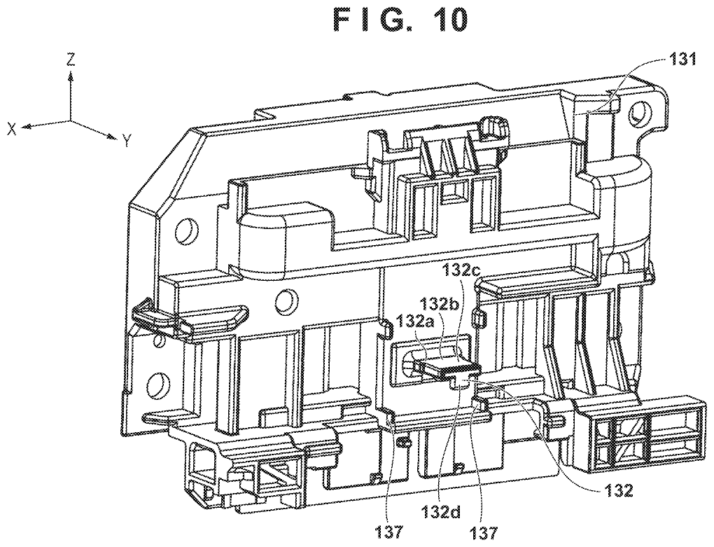

FIG. 10 is a perspective view of the back surface side of the rear cover 131. The support portion 132 is a shaft-like member protruding backward from a middle lower portion of the back surface of the rear cover 131 in the Y direction and supports each component of the fixing structure. The support portion 132 has a wide portion 132a, an intermediate portion 132b, a narrow portion 132c, and a distal end portion 132d when viewed from the rear cover 131 side. The wide portion 132a, the intermediate portion 132b, the narrow portion 132c each have a rectangular X-Z section. The wide portion 132a is wider than the narrow portion 132c in the X direction. The intermediate portion 132b is interposed between the wide portion 132a and the narrow portion 132c. The intermediated portion 132b gradually decreases in the width in the X direction from the wide portion 132a to the narrow portion 132c and smoothly connects the wide portion 132a to the narrow portion 132c. The distal end portion 132d has a portion protruding downward in the Z direction and has a T-shape when the support portion 132 is viewed from the Y direction.

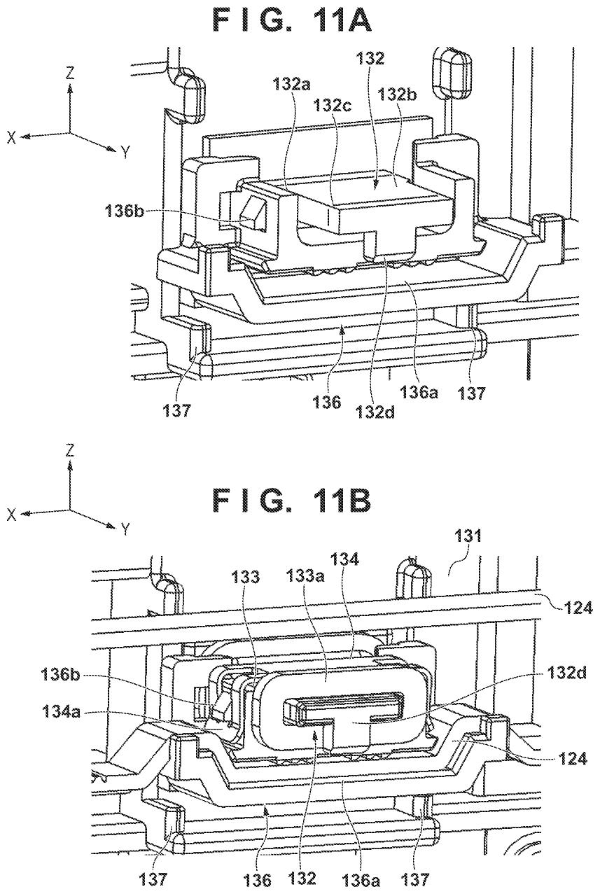

FIG. 11A shows a mode in which the holding member 136 is attached to the rear cover 131. The holding member 136 has a slit 136a that holds the endless belt 124 by vertically pinching it. In addition, a wedge-shaped engaging portion 136b with which the holder 134 engages is formed in each end portion of the holding member 136 in the X direction. The holding member 136 is restricted by the distal end portion 132d of the support portion 132 from moving in the Y direction.

FIG. 11B is a perspective view of the fixing structure after assembly. The damper 133 is an elastic member (especially a viscoelastic member) having a vibration proof effect, such as synthetic rubber, and has a tubular shape in which the support portion 132 is inserted. The damper 133 has a flange portion 133a at its end portion. The flange portion 133a is sandwiched between the distal end portion 132d and the holding member 136.

The holder 134 is an inverted U-shaped member and has an engaging portion 134a having an opening in which the engaging portion 136b of the holding member 136 is inserted. The holder 134 is attached to the holding member 136 from above the support portion 132. The holder 134 presses the damper 133 against the support portion 132 from above and restricts the movement of the holding member 136 with respect to the support portion 132 in the Z direction.

The rear cover 131 is provided with two rotation restricting portions 137. The rotation restricting portions 137 is a portion protruding backward from the rear cover 131 and restricts the inclination of the holding member 136 with respect to the traveling direction (X direction) of the endless belt 124. In other words, the rotation restricting portions 137 function as rotation stops for stopping rotation around the Y-axis of the holding member 136.

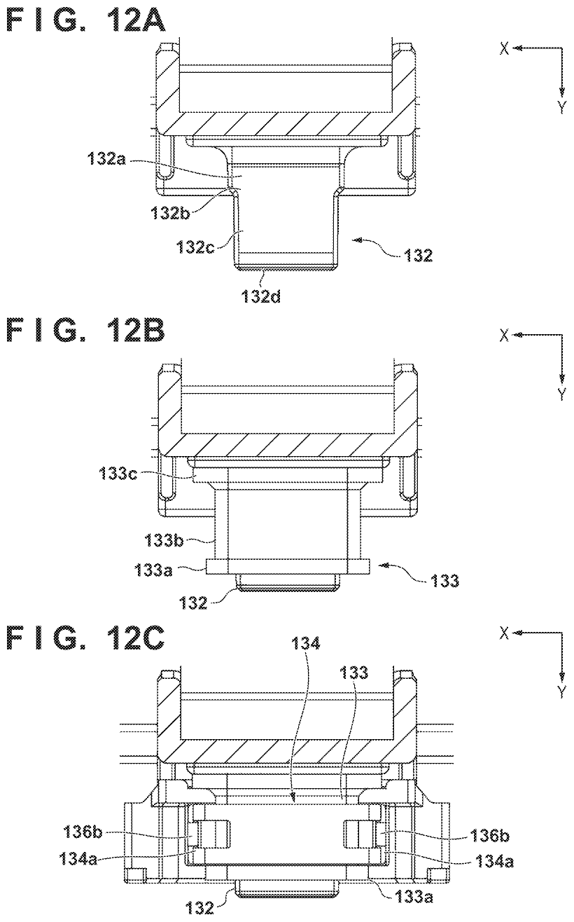

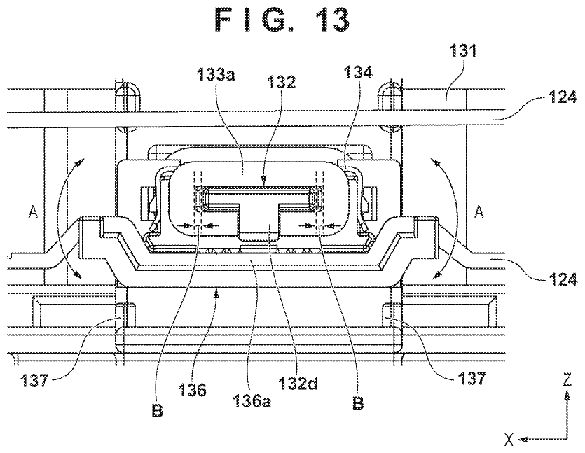

The dimensional relationship between the support portion 132 and the damper 133 and the function of the rotation restricting portions 137 will be described with reference to FIGS. 12A to 13. FIG. 12A is a plan view of the support portion 132 and indicates a change in the width of the support portion 132 in the X direction. As already described above, the wide portion 132a is wider than the narrow portion 132c in the X direction. The intermediate portion 132b gradually changes in width in the X direction.

FIG. 12B is a plan view showing a mode in which the damper 133 is attached to the support portion 132. The damper 133 has a flange portion 133a, a main body portion 133b, and a root portion 133c. The main body portion 133b is narrower than the flange portion 133a and the root portion 133c in the X direction. On the other hand, the through hole of the damper 133 into which the support portion 132 is inserted has a sectional shape and size that make the wide portion 132a of the support portion 132 perfectly match (or be fitted in) the through hole. The same applies to the flange portion 133a, the main body portion 133b, and the root portion 133c. The support portion 132 gradually increases in width in the X direction from the distal end portion 132d side toward the narrow portion 132c, the intermediate portion 132b, and the wide portion 132a. This makes it easy to attach the damper 133 to the support portion 132.

FIG. 12C shows a mode in which the holding member 136 and the holder 134 in the state shown in FIG. 12B are attached to the support portion 132. The holder 134 is provided so as to cross the main body portion 133b of the damper 133.

FIG. 13 is a rear view of the fixing structure viewed in the Y direction. As described above, the through hole of the damper 133 into which the support portion 132 is inserted has a sectional shape and size that make the wide portion 132a of the support portion 132 be perfectly fitted in the through hole. This restricts the positions of the damper 133 with respect to the support portion 132 in the X and Z directions. On the other hand, since the narrow portion 132c of the support portion 132 is narrower than the through hole of the damper 133 in the X direction, a gap B is formed between the narrow portion 132c and the through hole of the damper 133 in the X direction.

When the carriage 13 moves, vibration due to the characteristics of the carriage motor 121 and the like propagates to the holding member 136, the damper 133, the support portion 132, the rear cover 131, and the carriage 13 in this order through the endless belt 124. When the holding member 136 tries to rotate in the A direction due to such vibration, the rotation restricting portion 137 restricts the rotation. In addition, owing to the gap B, the damper 133 has a degree of freedom in the X direction with respect to vibration and can efficiently absorb such vibration. In addition, vibration absorption based on the elastic deformation of the damper 133 makes it possible to effectively attenuate the vibration propagating to the carriage 13. Attenuating the vibration of the carriage 13 allows the printhead 14 to stably discharge ink, thereby providing accurate printing.

As the structure concerning the reduction of vibration due to the characteristics of the carriage motor 121 and the like, various structures can be adopted other than the above example. For example, the support portion 132 may have a round bar shape or elliptic shape instead of the rectangular parallelepiped shape, and the shape of the damper 133 can be selected in accordance with the shape of the support portion 132. In addition, the main body 130 of the carriage 13 may be provided with the support portion 132 without being provided with the rear cover 131. In addition, it is possible to adopt an arrangement without the damper 133. This arrangement has the same structure as that of the arrangement shown in FIG. 11A. Even with the arrangement without the damper 133, rigidity adjustment by the support portion 132 and the elastic deformation of the support portion 132 can absorb vibration and reduce the vibration propagating to the carriage 13.

### <Control Circuit>

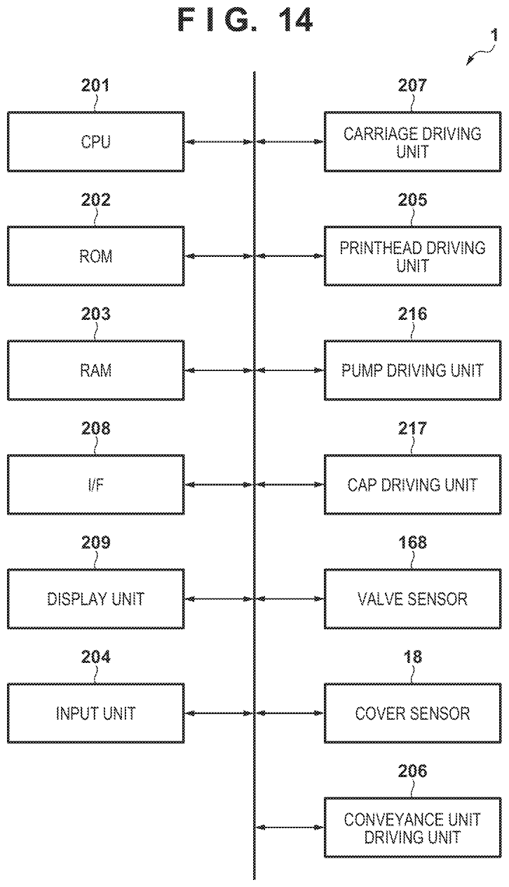

FIG. 14 is a block diagram of the control circuit of the liquid discharge apparatus 1. A CPU 201 is a processor that comprehensively controls the liquid discharge apparatus 1. A ROM 202 and a RAM 203 are examples of a storage device. The ROM 202 stores control programs of the CPU 201, various data, and the like. The RAM 203 temporarily stores various data. For example, the CPU 201 loads a program stored in the ROM 202 into the RAM 203 and executes the program to execute operation control and data processing for the control system 100.

A printhead driving unit 205 performs discharge control of ink onto the print medium P with the printhead 14 in accordance with the control signal transmitted from the CPU 201. A carriage driving unit 207 controls the movement of the carriage 13 by driving the carriage motor 121. The pump driving unit 216 drives a motor for the suction pump 214. A cap driving unit 217 drives a motor for moving the suction cap 211 back and forth. A conveyance unit driving unit 206 drives a motor for the conveyance unit 11. An external I/F 208 is connected to a PC or the like to receive print data and the like and transmit status signals and the like.

A display unit 209 displays various types of user interface screens such as an apparatus information screen, a setting screen, and a job information screen. For example, the display unit 209 is a liquid crystal display. For example, the display unit 209 may be provided at a position on the apparatus main body 2 which facilitates the user to visually check. An input unit 204 receives an input from the user. For example, the input unit 204 may be a touch panel or physical keys. The detection results obtained by the cover sensor 18 and the valve sensor 168 are transmitted to the CPU 201.

### <Control Example>

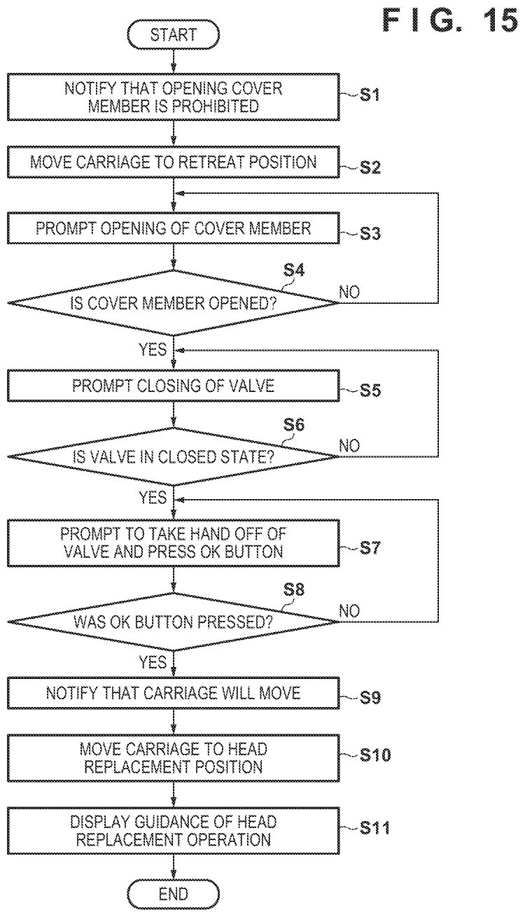

FIG. 15 is a flowchart showing an example of processing by the CPU 201 at the time of replacement of the printhead 14. This processing is implemented by causing the CPU 201 to load a program stored in the ROM 202 into the RAM 203 and execute the processing. This processing is executed when predetermined conditions concerning the replacement of the printhead 14 are satisfied. The predetermined conditions include, for example, whether any abnormality is detected in the printhead 14, whether the degree of use of the printhead 14 has reached a specified value, and whether the user has given an instruction for replacement. The abnormality includes a case in which it is determined that an ink discharge failure has occurred. The degree of use is specified by, for example, the period of time, the number of days, or a discharge count.

When the printhead 14 is to be replaced, the carriage 13 needs to be moved. In step S1, the user is notified that opening of the cover member 3 is prohibited. This notification can be performed by, for example, displaying information indicating “keep closed” on the display unit 209 or outputting a sound from a loudspeaker (not shown). The same applies concerning notification in the following description. Moving the carriage 13 while the cover member 3 is at the closed position can prevent the carriage 13 from interfering with an external foreign substance.

Subsequently, in step S2, the CPU 201 moves the carriage 13 to the retreat position. FIG. 8 shows a state in which the carriage 13 is located at the retreat position. In this embodiment, the retreat position is an end portion of the movement region R on the away side in the X direction.

In step S3, the CPU 201 prompts the user to open the cover member 3. In step S4, the CPU 201 obtains the detection result obtained by the cover sensor 18 and checks, based on the obtained detection result, whether the cover member 3 is opened. If the cover 3 is open, the CPU 201 causes the process to advance to step S5. If the cover member 3 is closed, the CPU 201 repeats the processing in step S4 and does not move the carriage 13 to the replacement position (to be described later). Note that this embodiment is configured to determine the opening/closing of the cover member 3 based on the detection result obtained by the cover sensor 18. However, the opening/closing of the cover member 3 may be determined based on whether the input unit 204 has received an input indicating that the user has opened the cover member 3.

In step S5, the CPU 201 prompts the user to close the valve 16. This can prevent ink leakage in replacing the printhead 14. At this time, as shown in FIG. 8, the carriage 13 is located at the retreat position. The pipe 15 located above the valve 16 is covered by the housing 2a. This can prevent the user from accidentally touching the pipe 15 and breaking it at the time of operating the valve 16. Note that if the user opens the cover member 3 in a state in which the valve 16 need not be operated, the carriage 13 is controlled to stay at an end portion of the movement region R on the home side in the X direction.

In step S6, the CPU 201 determines whether the valve 16 is in the closed state. For example, the CPU 201 obtains the detection result obtained by the valve sensor 168 and determines, based on the obtained detection result, whether the valve 16 is closed. Upon determining that the valve 16 is in the closed state, the CPU 201 causes the process to advance to step S7. If the valve 16 is not in the closed state, the CPU 201 repeats the processing in step S6 and does not move the carriage 13 to the replacement position described later.

In step S7, the CPU 201 prompts the user to take his/her hand off of the opening/closing operation unit 161 and input information indicating the completion of the operation on the input unit 204, for example, press the OK button. Upon detecting in step S8 that the OK button is pressed, the CPU 201 notifies the user in step S9 that the carriage 13 will move to the position (replacement position) for a replacing operation with respect to the printhead 14. If the pressing of the OK button is not detected, the CPU 201 repeats steps S7 and S8 and does not move the carriage 13 to the replacement position.

In step S10 after step S9, the CPU 201 moves the carriage 13 to the replacement position. FIG. 3 shows a state in which the carriage 13 is located at the replacement position. In this embodiment, the replacement position is the position of a middle portion of the movement region R in the X direction. The replacement position is set at the middle portion of the apparatus main body 2 to allow the user to perform a replacing operation and facilitate the replacing operation.

In step S11, the display unit 209 displays a guidance for a replacing operation for the printhead 14. The user views the guidance and performs the replacing operation for the printhead 14. The processing is then terminated.

In this embodiment, a replacing operation is performed for the printhead 14 following the procedure: moving carriage 13 to retreat position→shutting valve 16→moving carriage 13 to replacement position. The example of the processing in FIG. 15 is the processing that requires an operation with respect to the opening/closing operation unit 161 of the valve 16 as a start condition. Assume that after a shutting operation for the valve 16, a hand of the user is left near the valve 16. In this case, since the valve 16 is placed near the movement region R of the carriage 13, the user may be surprised by sudden appearance of the carriage 13. In addition, the suddenly moving the carriage 13 may come into contact with the hand of the user or the like.

In this embodiment, the retreat position is located on the opposite side of the opening/closing operation unit 161 to the replacement position in the X direction. Unlike the case where the carriage 13 moves from a position on the home side to the replacement position, the carriage 13 does not pass near the valve 16. Before reaching the valve 16 in the X direction, the carriage 13 stops at the replacement position. This makes it possible to prevent the movement of the carriage 13 from surprising the user and to achieve safer movement of the carriage.

After the closed state of the valve 16 is detected (step S6), the cover member 3 is temporarily moved to the closed position. It is possible to use control of moving the carriage 13 to the replacement position while the cover member 3 is at the closed position. In this case, however, the user needs to move the cover member 3 to the open position again to replace the printhead 14, resulting in an increase in the number of work steps. As in this embodiment, since this problem is coped with by devising how to set the retreat position, it is possible to prevent an increase in the number of work steps and also improve the usability.

The user is required to operate the OK button upon completion of the operation on the valve 16 to the closed state (step S7). In addition, when the carriage 13 is moved from the retreat position to the replacement position, the corresponding information is notified to the user (step S9). This makes it possible to reliably prevent the user from being surprised.

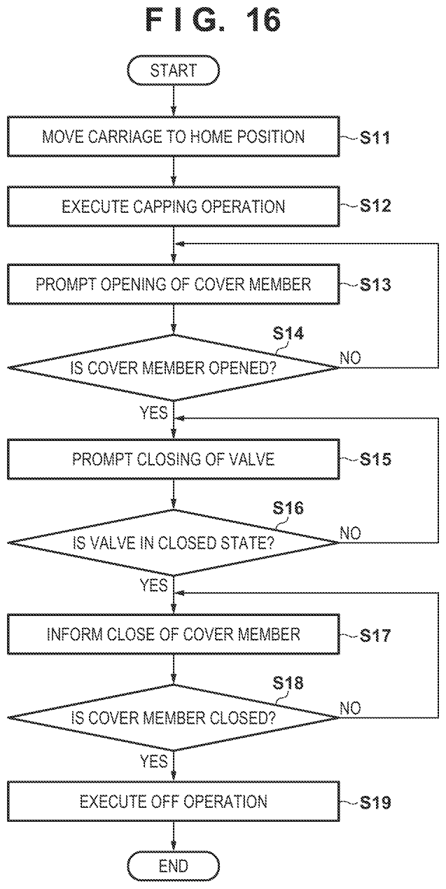

Another example of processing by the CPU 201 will be described next. FIG. 16 is a flowchart showing an example of processing by the CPU 201 in a transportation mode. When the liquid discharge apparatus 1 is transported from the user to a support center for the repair or maintenance of the liquid discharge apparatus 1, some measures against ink leakage are sometimes required. In addition, when the liquid discharge apparatus 1 is stored without use for a long period of time, the valve 16 is preferably closed.

Accordingly, when the control mode has changed to the transportation mode, the liquid discharge apparatus 1 according to this embodiment performs a series of processing for prompting the user to close the valve 16. For example, this flowchart is implemented by causing the CPU 201 to load a program stored in the ROM 202 into the RAM 203 and execute the program.

In an operation of opening the cover member 3 in the transportation mode or in a normal state, the carriage 13 need not be moved to the replacement position. Accordingly, in step S11, the carriage 13 has been retreated to the position of an end portion (to be referred to as the home position) of the movement region R on the home side in the X direction. At the home position, the printhead 14 faces the suction cap 211. In step S12, a capping operation is executed to hermitically seal the discharge surface 14a with the suction cap 211.

In step S13, the CPU 201 prompts the user to open the cover member 3. In step S14, the CPU 201 obtains the detection result obtained by the cover sensor 18 and checks, based on the obtained detection result, whether the cover member 3 is opened. If the cover member 3 is opened, the CPU 201 causes the process to advance to step S15. If the cover member 3 is closed, the CPU 201 repeats the processing in step S14. Although this embodiment is configured to determine the opening/closing of the cover member 3 based on the detection result obtained by the cover sensor 18, the opening/closing of the cover member 3 may be determined based on whether the input unit 204 has received an input indicating the opening of the cover member 3 from the user.

In step S15, the CPU 201 prompts the user to close the valve 16. In step S16, the CPU 201 determines whether the valve 16 is in the closed state. For example, the CPU 201 obtains the detection result obtained by the valve sensor 168 and determines, based on the obtained detection result, whether the valve 16 is closed. Upon determining that the valve 16 is in the closed state, the CPU 201 causes the process to advance to step S17. Otherwise, the CPU 201 repeats the processing in step S16.

In step S17, the CPU 201 prompts the user to close the cover member 3. In step S18, the CPU 201 obtains the detection result obtained by the cover sensor 18 and checks, based on the obtained detection result, whether the cover member 3 is closed. If the cover member 3 is closed, the CPU 201 causes the process to advance to step S19. If the cover member 3 is not closed, the CPU 201 repeats the processing in step S17. Although this embodiment is configured to determine the opening/closing of the cover member 3 based on the detection result obtained by the cover sensor 18, the opening/closing of the cover member 3 may be determined based on whether the input unit 204 has received an input indicating that the user has opened the cover member 3.

In step S19, an OFF operation (a power OFF operation by software) is executed. The processing in the transportation mode is then completed. In this embodiment, in the transportation mode, the CPU 201 performs a power OFF operation upon confirming that the valve 16 is closed. Accordingly, when the power supply of the liquid discharge apparatus 1 is turned off while the transportation mode is selected, the valve 16 is always closed. This prevents the user from forgetting to execute measures against ink leakage at the time of the transportation of the liquid discharge apparatus 1.

### Other Embodiments

The above embodiment has exemplified the processing of requiring the operation of the opening/closing operation unit 161 of the valve 16 in the processing of moving the carriage 13 to the middle portion (replacement position) upon moving the carriage 13 to the retreat position. However, the present invention is not limited thereto with respect to the operation target of the user and the destination of the carriage 13 from the retreat position. The operation target of the user may be, for example, an operation on the operation unit for solving a paper jam. The destination of the carriage 13 may be a position shifted from the middle portion of the movement region R instead of the middle portion. The work purposes may include various types of maintenance for the carriage 13 (sensor replacing operation) in addition to a replacing operation for the printhead 14.

The present invention can also be implemented by the processing of supplying a program for implementing one or more functions of the above embodiment to a system or an apparatus via a network or a storage medium and reading out and executing the program by one or more processors in a computer of the system or apparatus. A circuit for implementing one or more functions (such as an ASIC) can also be used for implementation.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-123762, filed Jul. 28, 2023, which is hereby incorporated by reference herein in its entirety.

What is claimed is:

1. A liquid discharge apparatus comprising:
a carriage on which a discharge head configured to discharge a liquid is mounted, the carriage being configured to move in a predetermined direction; and
an operation unit configured to be placed near a movement region of the carriage and configured to be operated by a user,
wherein when a predetermined condition is satisfied, the carriage moves to a retreat position on the movement region and then moves to a predetermined position on the movement region, and
the retreat position is a position on an opposite side of the predetermined position to the operation unit in the predetermined direction.

2. The apparatus according to claim 1, wherein the predetermined condition is a start condition for processing, the start condition requiring an operation on the operation unit.

3. The apparatus according to claim 1, wherein the predetermined position is a position at which a user can perform an operation with respect to the carriage.

4. The apparatus according to claim 1, wherein the predetermined position is a middle portion of the movement region.

5. The apparatus according to claim 3, wherein the operation is a replacing operation for the discharge head.

6. The apparatus according to claim 1, wherein the operation unit is a valve configured to switch between supply and interruption of a liquid with respect to the discharge head.

7. The apparatus according to claim 6, wherein the valve is provided on a pipe between the discharge head and a reservoir configured to retain the liquid.

8. The apparatus according to claim 7, wherein the valve interrupts supply of the liquid by crushing the pipe.

9. The apparatus according to claim 7, wherein the pipe is routed so as to avoid a position above the operation unit.

10. The apparatus according to claim 1, wherein the retreat position is a position on one end portion of the movement region in the predetermined direction, and
the other end portion of the movement region is provided with a recovery unit configured to recover discharge performance of the discharge head.

11. The apparatus according to claim 1, further comprising a detection unit configured to detect an operation on the operation unit,
wherein when an operation is not detected by the detection unit after the carriage is moved to the retreat position, the carriage is not moved to the predetermined position.

12. The apparatus according to claim 1, further comprising a notification unit configured to prompt a user to release a hand off the operation unit after movement of the carriage to the retreat position.

13. The apparatus according to claim 12, wherein when the user does not respond to a notification from the notification unit, the carriage is not moved to the predetermined position.

14. The apparatus according to claim 1, further comprising:
a cover member configured to open and close between a closed position to cover the carriage and the operation unit and an open position to expose the carriage and the operation unit;
a detection unit configured to detect an open/closed state of the cover member; and
a notification unit configured to prompt a user to displace the cover member to the open position after movement of the carriage to the retreat position and to prompt the user to operate the operation unit when the detection unit detects displacement of the cover member to the open position.

15. The apparatus according to claim 1, further comprising a belt transmission mechanism configured to move the carriage in the predetermined direction,
wherein the carriage includes a support portion and a holding member attached to the support portion through an elastic member and configured to hold an endless belt of the belt transmission mechanism, and
the support portion includes a wide portion with which the elastic member is in close contact and a narrow portion having a gap with the elastic member.

16. The apparatus according to claim 15, wherein the support portion has a middle portion located between the wide portion and the narrow portion and gradually decreasing in width from the wide portion to the narrow portion.

17. The apparatus according to claim 15, wherein the carriage has a restricting portion configured to restrict inclination of the holding member with respect to a traveling direction of the endless belt.

18. A control method for a liquid discharge apparatus including: a carriage on which a discharge head configured to discharge a liquid, the carriage being configured to move in a predetermined direction; and an operation unit placed near a movement region of the carriage and configured to be operated by a user, the method comprising
moving the carriage to a retreat position on the movement region and then moving the carriage to a predetermined position on the movement region when a predetermined condition is satisfied,
wherein the retreat position is a position on an opposite side of the predetermined position to the operation unit in the predetermined direction.
